(19) United States
(12) Patent Application Publication
(10) Pub. No.: US 2014/0108541 A1
(43) Pub. Date: Apr. 17, 2014

(54) TERMINAL APPARATUS, TERMINAL CONTROL METHOD, INFORMATION PROCESSING APPARATUS, INFORMATION PROCESSING METHOD, AND PROGRAM

(71) Applicant: Sony Corporation, Tokyo (JP)

(72) Inventor: Toshihiko Kawai, Kanagawa (JP)

(73) Assignee: SONY CORPORATION, Tokyo (JP)

(21) Appl. No.: 14/049,604

(22) Filed: Oct. 9, 2013

(30) Foreign Application Priority Data
Oct. 16, 2012 (JP) 2012-228888

(51) Int. Cl. H04L 29/08

(52) U.S. Cl. CPC H04L 67/22
USPC 709/204

(57) ABSTRACT

A terminal apparatus includes: a transmission section configured to transmit a subject image obtained by shooting a predetermined subject or an image feature quantity thereof to another information processing apparatus; from the other information processing apparatus configured to recognize the subject of the subject image on the basis of the image feature quantity, to determine review information stored in the other information processing apparatus by a social networking service to be corresponding to the subject image, and to transmit the review information, a reception section configured to receive the review information; and a display section configured to display the received review information together with the subject image.

### CROSS REFERENCE TO RELATED APPLICATIONS

This application claims the benefit of priority under U.S.C. §119 from Japanese Priority Patent Application JP 2012-228888 filed Oct. 16, 2012, the entire contents of which are incorporated herein by reference.

### BACKGROUND

The present disclosure relates to terminal apparatuses, terminal control methods, information processing apparatuses, information processing methods, and programs. In particular, the present disclosure relates to a terminal apparatus capable of providing new services that make better use of opinions and comments created by users, a terminal control method, an information processing apparatus, an information processing method, and a program.

In recent years, Web services, such as blogs, social networking services (SNS), and so on have become widespread, and thus it becomes possible for an Internet user in general to easily send out an opinion and a comment to a network. Also, in an SNS, users are allowed to share information on what one of the users has viewed, or what has interested one of the users with one another.

Techniques that are useful when users create opinions and comments in Web services have also been proposed. For example, when a user introduces a comment on a music to which the user has listened in a blog of the user, there is a technique by which the user is allowed to create a comment with reference to words and expressions used by another user in his or her blog, and so on (for example, refer to Japanese Unexamined Patent Application Publication No. 2010-286910).

### SUMMARY

However, review information, such as opinions, comments, and so on created by each user is separated, and thus it is difficult to say that the review information is fully utilized.

The present technique has been made in view of these circumstances. It is desirable to provide a new service that makes better use of opinions and comments created by a user.

According to an embodiment of the present disclosure, there is provided a terminal apparatus including: a transmission section configured to transmit a subject image obtained by shooting a predetermined subject or an image feature quantity thereof to another information processing apparatus; from the other information processing apparatus configured to recognize the subject of the subject image on the basis of the image feature quantity, to determine review information stored in the other information processing apparatus by a social networking service to be corresponding to the subject image, and to transmit the review information, a reception section configured to receive the review information; and a display section configured to display the received review information together with the subject image.

According to another embodiment of the present disclosure, there is provided a method of controlling a terminal, the method including: transmitting a subject image obtained by shooting a predetermined subject or an image feature quantity thereof to another information processing apparatus; from the other information processing apparatus configured to recognize the subject of the subject image on the basis of the image feature quantity, to determine review information stored in the other information processing apparatus by a social networking service to be corresponding to the subject image, and to transmit the review information, receiving the review information; and displaying the received review information together with the subject image on a display section.

According to another embodiment of the present disclosure, there is provided a program for causing a computer to perform processing including: transmitting a subject image obtained by shooting a predetermined subject or an image feature quantity thereof to another information processing apparatus; from the other information processing apparatus configured to recognize the subject of the subject image on the basis of the image feature quantity, to determine review information stored in the other information processing apparatus by a social networking service to be corresponding to the subject image, and to transmit the review information, receiving the review information; and displaying the received review information together with the subject image on a display section.

By the above-described embodiment of the present technique, a subject image obtained by shooting a predetermined subject or an image feature quantity thereof is transmitted to another information processing apparatus, from the other information processing apparatus configured to recognize the subject of the subject image on the basis of the image feature quantity, to determine review information stored in the other information processing apparatus by a social networking service to be corresponding to the subject image, and to transmit the review information, the review information is received; and the received review information is displayed on a display section together with the subject image.

According to another embodiment of the present disclosure, there is provided an information processing apparatus including: a storage section configured to store review information extracted from posted information on a predetermined subject posted by a social networking service; a reception section configured to receive a subject image obtained by a terminal apparatus shooting the subject or an image feature quantity thereof; a review information determination section configured to determine review information corresponding to the subject image received or the image feature quantity thereof on the basis of the review information stored in the storage section; and a transmission section configured to transmit the review information determined as review information corresponding to the subject image.

According to another embodiment of the present disclosure, there is provided a method of processing information, the method including: storing review information extracted from posted information on a predetermined subject posted by a social networking service into a storage section; receiving a subject image obtained by a terminal apparatus shooting the subject or an image feature quantity thereof; determining review information corresponding to the subject image received or the image feature quantity thereof on the basis of the review information stored in the storage section; and transmitting the review information determined as review information corresponding to the subject image.

According to another embodiment of the present disclosure, there is provided a program for causing a computer to perform processing including: storing review information extracted from posted information on a predetermined subject posted by a social networking service into a storage section; receiving a subject image obtained by a terminal apparatus shooting the subject or an image feature quantity thereof; determining review information corresponding to the subject image received or the image feature quantity thereof on the basis of the review information stored in the storage section; and transmitting the review information determined as review information corresponding to the subject image.

By the above-described embodiment of the present technique, review information extracted from posted information on a predetermined subject posted by a social networking service is stored into a storage section; a subject image obtained by a terminal apparatus shooting the subject or an image feature quantity thereof is received by a terminal apparatus; review information corresponding to the subject image received or the image feature quantity thereof is determined on the basis of the review information stored in the storage section; and the review information determined is transmitted to the terminal apparatus as review information corresponding to the subject image.

In this regard, it is possible to provide the program by transmitting through a transmission medium, or by being recorded on a recording medium.

The terminal apparatus and the information processing apparatus may be individually an independent apparatus, or may be internal blocks that constitute one apparatus.

By embodiments of the present technique, it is possible to provide a new service that makes better use of opinions and comments created by a user.

### BRIEF DESCRIPTION OF THE DRAWINGS

FIG. 1 is a block diagram illustrating an example of a configuration of an information processing system to which an embodiment of the present technique is applied;

FIGS. 2A and 2B are diagrams illustrating a real comment function;

FIG. 3 is a functional block diagram of a mobile terminal and a Web server;

FIG. 4 is a diagram illustrating data examples of a dish photo DB;

FIG. 5 is a diagram illustrating data examples of a dish keyword DB;

FIG. 6 is a block diagram illustrating an example of a hardware configuration of a mobile terminal;

FIG. 7 is a block diagram illustrating an example of a hardware configuration of a Web server;

FIG. 8 is a flowchart illustrating real comment processing;

FIG. 9 is a flowchart illustrating details of real comment generation processing;

FIG. 10 is a flowchart illustrating details of eating place identification processing;

FIG. 11 is a flowchart illustrating details of dish identification processing;

FIG. 12 is a diagram illustrating an example of a user interface of the real comment function;

FIG. 13 is a diagram illustrating an example of a user interface of the real comment function;

FIG. 14 is a diagram illustrating an example of a user interface of the real comment function;

FIG. 15 is a diagram illustrating an example of a user interface of the real comment function;

FIG. 16 is a diagram illustrating a display example of review information, and the like;

FIG. 17 is a flowchart illustrating keyword registration processing;

FIG. 18 is a diagram illustrating an example of keyword extraction; and

FIGS. 19A and 19B are explanatory diagrams of another application.

### DETAILED DESCRIPTION OF EMBODIMENTS

In the following, descriptions will be given of modes for carrying out the present technique (hereinafter, referred to as embodiments). In this regard, the descriptions will be given in the following order.

1. Example of configuration of information processing system

2. Explanation of real comment function

3. Functional block diagram of mobile terminal and Web server

4. Example of hardware configuration of mobile terminal

5. Example of hardware configuration of Web server

6. Real comment processing

7. Examples of user interfaces

8. Keyword registration processing

9. The other applications

### 1. Example of Configuration of Information Processing System

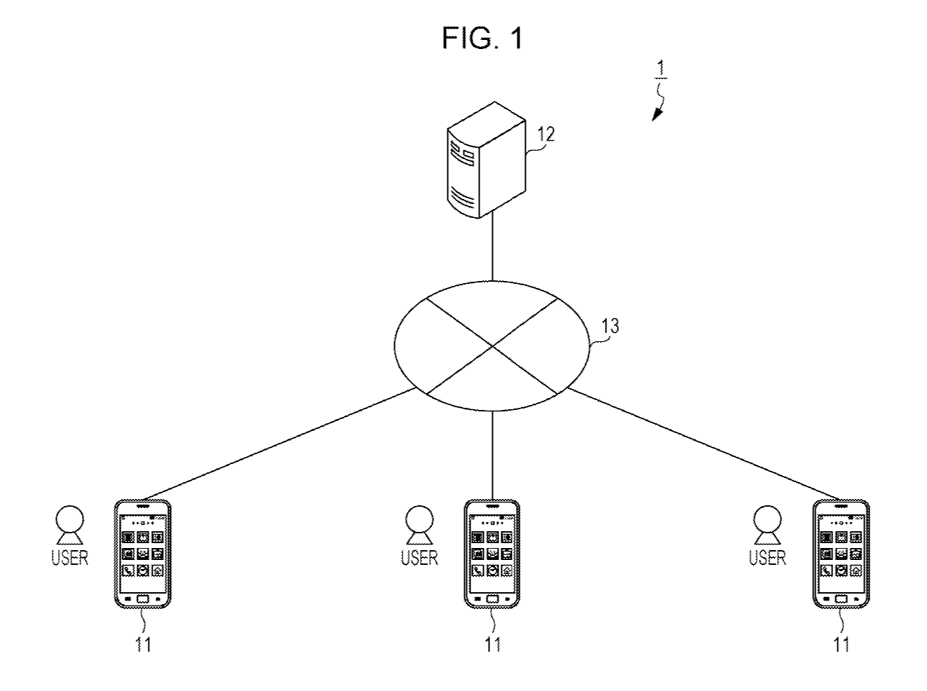

FIG. 1 illustrates an example of a configuration of an information processing system to which an embodiment of the present technique is applied.

An information processing system 1 illustrated in FIG. 1 is a system that provides general users with a social networking service (hereinafter referred to as an SNS). A mobile terminal 11 operated by each user and a Web server 12, which is a server apparatus that provides an SNS at a predetermined Web site, are connected through a network 13.

The mobile terminal 11 is called a smart phone in general, and is a highly functional terminal (mobile phone apparatus) produced by integrating a mobile phone and a mobile information terminal, which is operated by a user who owns the mobile terminal.

A plurality of application programs (applications) are pre-installed in the mobile terminal 11. For example, the mobile terminal 11 is provided with a Web browser (full browser) capable of browsing Web sites designed for personal computers. Also, the mobile terminal 11 has a shooting function and a Global Positioning System (GPS) function.

A user of each mobile terminal 11 is a member of an SNS (community) provided by the Web server 12. It is possible for each user to exchange information with the other users on a Web site provided by the Web server 12.

The Web server 12 is a server apparatus having a function of providing a site for exchanging information among the users who are community members. Also, the Web server 12 is sometimes further provided with functions of blogs, bulletin boards, and so on.

In the present embodiment, it is assumed that the Web server 12 provides a site for exchanging information on eating places of restaurants. For example, a user is allowed to start a Web browser of the mobile terminal 11, to access a site on the Web server 12, to upload a photo of a dish eaten at an eating place where the user has visited, and to comment (write) on impressions. Also, the user is allowed to share those comments and photos with the other users.

The network 13 is formed, for example, by a public network, such as the Internet, a telephone line network, a satellite communication network, and the like, a Local Area Network (LAN), a Wide Area Network (WAN), and so on.

In this regard, in the present embodiment, descriptions will be given on the assumption that the mobile terminal 11 is a smart phone. However, the mobile terminal 11 is not limited to a smart phone, and may be a tablet terminal, such as a Portable Navigation Device (PND), an electronic book reader, and so on, or a mobile terminal apparatus, such as a mobile music playback apparatus, a mobile game machine, and so on.

### 2. Explanation of Real Comment Function

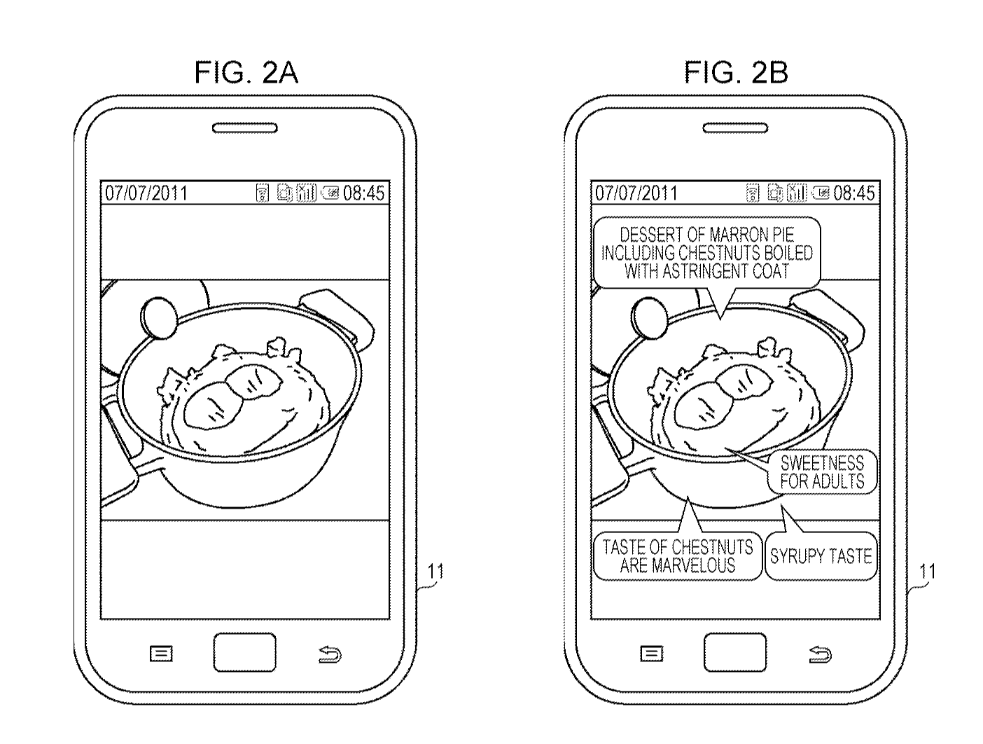

Next, a description will be given of a real comment function provided by the Web server 12 with reference to FIGS. 2A and 2B.

For example, a user shoots a “dessert of marron pie including chestnuts boiled with astringent coat” by the mobile terminal 11 as a subject as illustrated in FIG. 2A when the user went into a restaurant (coffee shop), and ordered the dessert. And the user uploads a dish photo (subject image) of the “dessert of marron pie including chestnuts boiled with astringent coat” obtained by the shooting to an SNS page on the Web server 12 from the mobile terminal 11.

Then, the dish photo of “dessert of marron pie including chestnuts boiled with astringent coat” is analyzed by the Web server 12. As a result of the analysis, an image as illustrated in FIG. 2B is displayed on the mobile terminal 11. That is to say, “dessert of marron pie including chestnuts boiled with astringent coat”, which is a dish name, and comments expressing the characteristics of this dish, such as “sweetness for adults”, “taste of chestnuts are marvelous”, and “syrupy taste”, and so on are displayed on the dish photo of “dessert of marron pie including chestnuts boiled with astringent coat”, which has been uploaded by the user.

In this manner, the Web server 12 has a real comment function of analyzing a dish photo at a restaurant that has been uploaded by a user, and displaying comments expressing the characteristics of the photo to the mobile terminal 11 of the user immediately (in real time).

In this regard, as described later, the comments expressing the characteristics of this dish, such as “sweetness for adults”, “taste of chestnuts are marvelous”, and “syrupy taste”, and so on are words (keywords) extracted from the comments that have been posted to the SNS before by the other users on this dish.

### 3. Functional Block Diagram of Mobile Terminal and Web Server

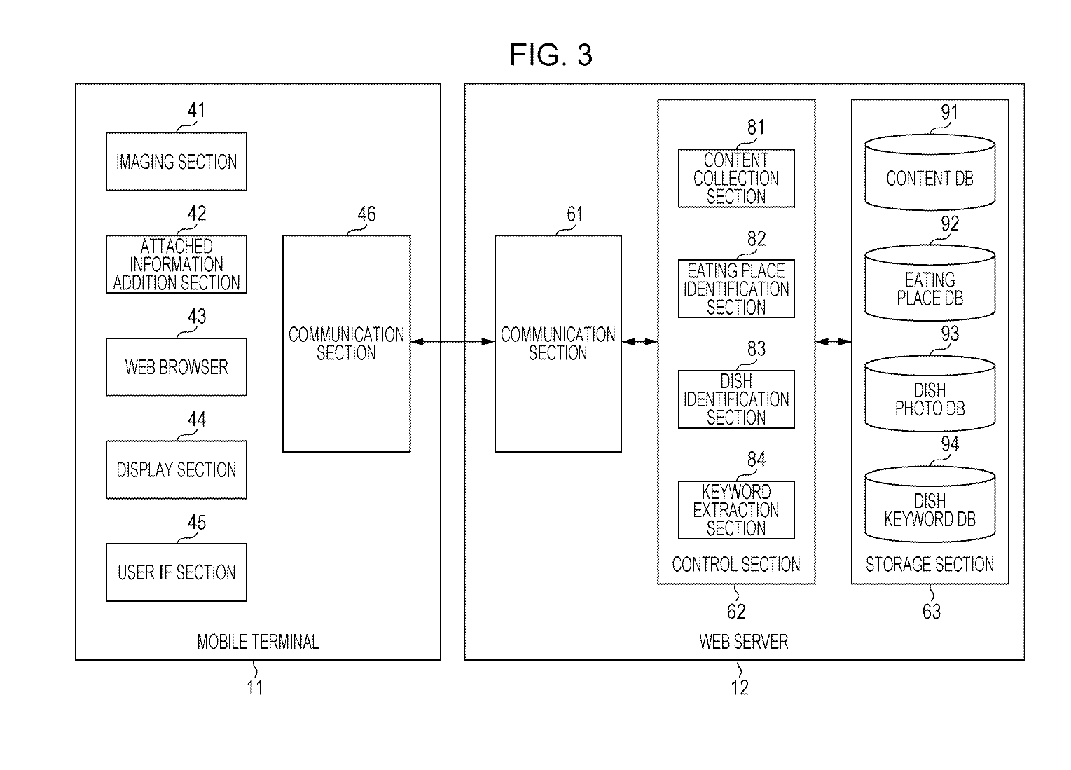

FIG. 3 illustrates a functional block diagram of the mobile terminal 11 and the Web server 12 at the time of achieving the real comment function.

The mobile terminal 11 includes an imaging section 41, an attached information addition section 42, a Web browser 43, a display section 44, a user IF section 45, and a communication section 46.

The imaging section 41 shoots a subject in accordance with a shooting instruction by the user. In the present embodiment, a dish eaten by the user at a restaurant is shot, for example.

The attached information addition section 42 adds attached information, such as shooting time indicating date and time at which the imaging section 41 shot the subject, positional information of the shooting location including latitude and longitude information, and so on to the image data of the subject image, and shapes the image data into a predetermined format, such as Exchangeable image file format (Exif), and so on. The positional information is obtained from a GPS control section not illustrated in FIG. 3, and the shooting time is obtained from a clock section not illustrated in FIG. 3.

The Web browser 43 accesses the Web server 12 through the communication section 46 using HTTP (HyperText Transfer Protocol), and displays information obtained from the Web server 12. Thereby, for example, a comment and a photo uploaded by the user are displayed on the Web browser 43.

The display section 44 displays the Web browser 43, or an image captured by the imaging section 41.

The user IF section 45 accepts operation, such as a shooting instruction on the imaging section 41, a comment input, and so on, and supplies the information corresponding to the accepted operation to each section.

The communication section 46 functions as a transmission section and a reception section that transmits and receives predetermined data to and from the Web server 12 through the network 13, respectively.

On the other hand, the Web server 12 includes a communication section 61, a control section 62, and a storage section 63.

The communication section 61 functions as a transmission section and a reception section that transmits and receives predetermined data to and from the mobile terminal 11 through the network 13, respectively. The communication section 61 supplies the received data from the mobile terminal 11 to the control section 62, and transmits the transmission data obtained from the control section 62 to the mobile terminal 11.

The control section 62 includes a content collection section 81, an eating place identification section 82, a dish identification section 83, and a keyword extraction section 84. The storage section 63 includes a content DB 91, an eating place DB 92, a dish photo DB 93, and a dish keyword DB 94.

The content collection section 81 obtains a dish photo and a comment transmitted from the mobile terminal 11, and stores the dish photo and the comment into the content DB 91. The content DB 91 stores comments and photos that have been uploaded by individual users who are members of the SNS.

The content collection section 81 also supplies a dish photo transmitted from the mobile terminal 11 to the eating place identification section 82, the dish identification section 83, and the keyword extraction section 84.

The eating place identification section 82 obtains positional information added to the dish photo from the content collection section 81 as attached information. And the eating place identification section 82 identifies an eating place providing a dish whose photo is taken in the dish photo on the basis of the positional information with reference to the eating place DB 92. The eating place DB 92 stores an eating place and positional information indicating the location thereof in association for each of the plurality of eating places located in various locations.

The dish identification section 83 extracts an image feature quantity of the dish photo supplied from the content collection section 81, and compares the image feature quantity with the image feature quantities of the dishes at each eating place stored in the dish photo DB 93 so as to identify the dish whose photo is taken in the dish photo supplied from the content collection section 81.

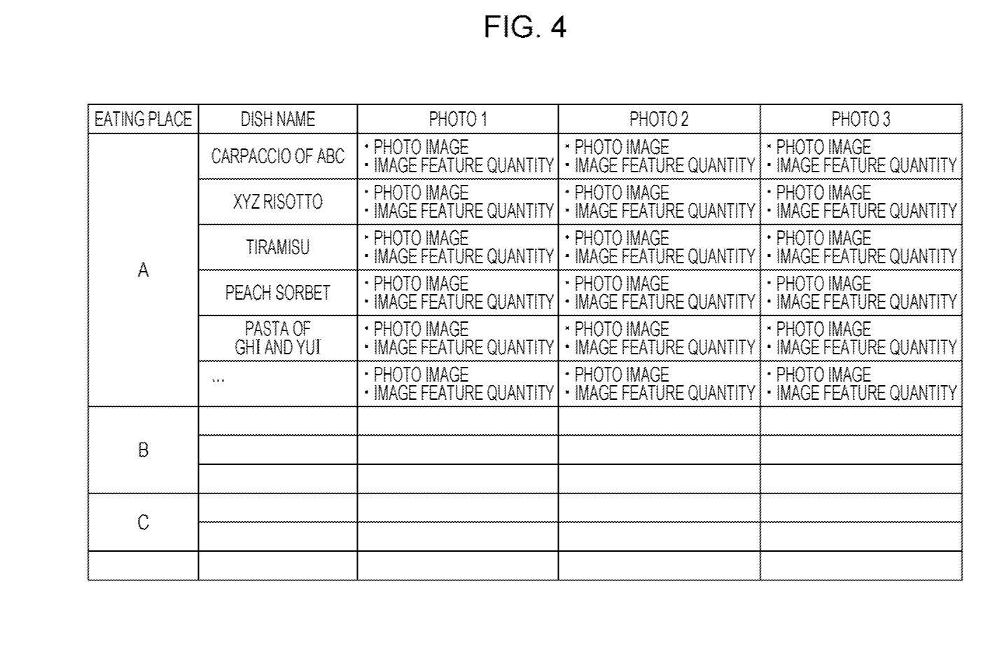

FIG. 4 illustrates data examples of the dish photo DB 93. The dish photo DB 93 stores dish names of dishes provided at each eating place, and the photo images of the dishes and the image feature quantities in association with each other for each eating place.

The data in the dish photo DB 93 is updated by members of the SNS shooting dishes at various eating places, and uploading the data to the Web server 12. In the case of creating data of the dish photo DB 93 for a new eating place, a staff member of the eating place registers dish names and photo images and the image feature quantities in advance.

Referring back to FIG. 3, the keyword extraction section 84 extracts a predetermined numbers of keywords corresponding to the dish identified by the dish identification section 83 from the dish keyword DB 94, and determines the comments corresponding to the dish taken in the dish photo transmitted from the mobile terminal 11.

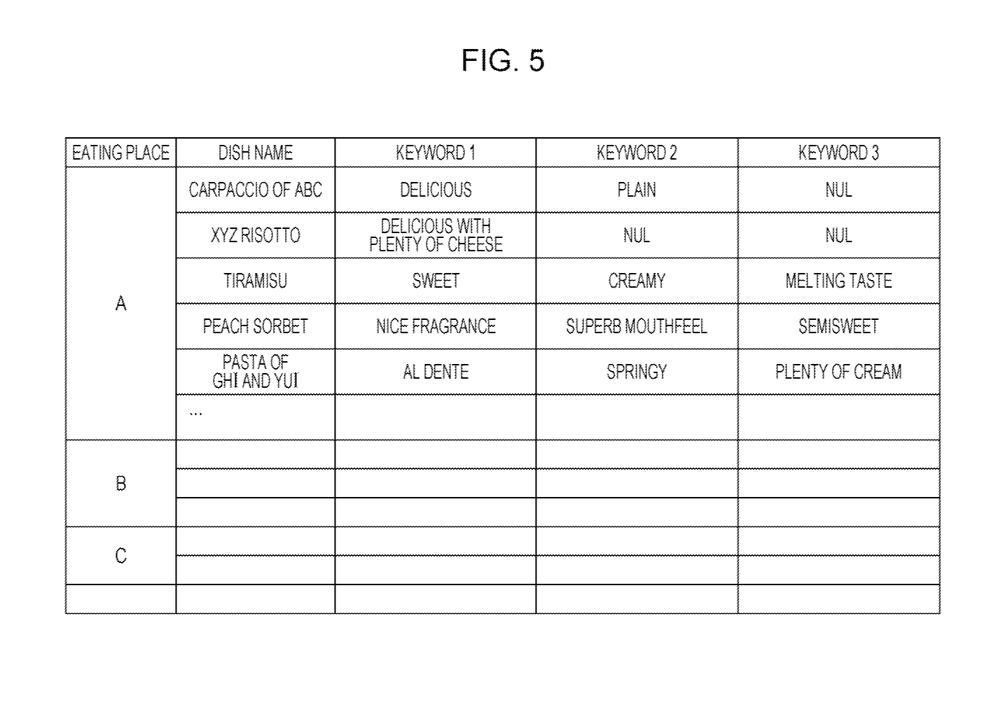

FIG. 5 illustrates data examples of the dish keyword DB 94. The dish keyword DB 94 stores dish names of dishes provided by the eating place, and keywords (comments) expressing the characteristics of the dish in association with each other for each eating place. For example, for a dish whose dish name “carpaccio of ABC” at an eating place name “A”, the keywords of “delicious” and “plain” are stored in association.

The data in the dish keyword DB 94 is produced by members of the SNS posting comments and blogs to the SNS when they ate dishes at each eating place, and the posted comments. Thereby, the data is uploaded to the Web server 12 and extracted to be stored.

In this regard, an eating place registered in the dish keyword DB 94 corresponds to (matches) an eating place stored in the eating place DB 92 and the dish photo DB 93.

The keyword extraction section 84 transmits the extracted keywords and the dish name of the dish to the mobile terminal 11 together with the dish photo transmitted from the mobile terminal 11 through the communication section 61. Thereby, an image as illustrated in FIG. 2B is displayed on the mobile terminal 11. In this regard, only the extracted keywords and the dish name of the dish may be transmitted to the mobile terminal 11, and may be displayed superimposedly on the dish photo displayed on the mobile terminal 11.

As described above, a dish photo (subject image), an image feature quantity thereof, and keywords are registered for each eating place in each database of the storage section 63 of the Web server 12. By narrowing down a recognition target of image recognition to each eating place, a recognition rate is improved compared with the case of simply identifying by an image feature quantity.

### 4. Example of Hardware Configuration of Mobile Terminal

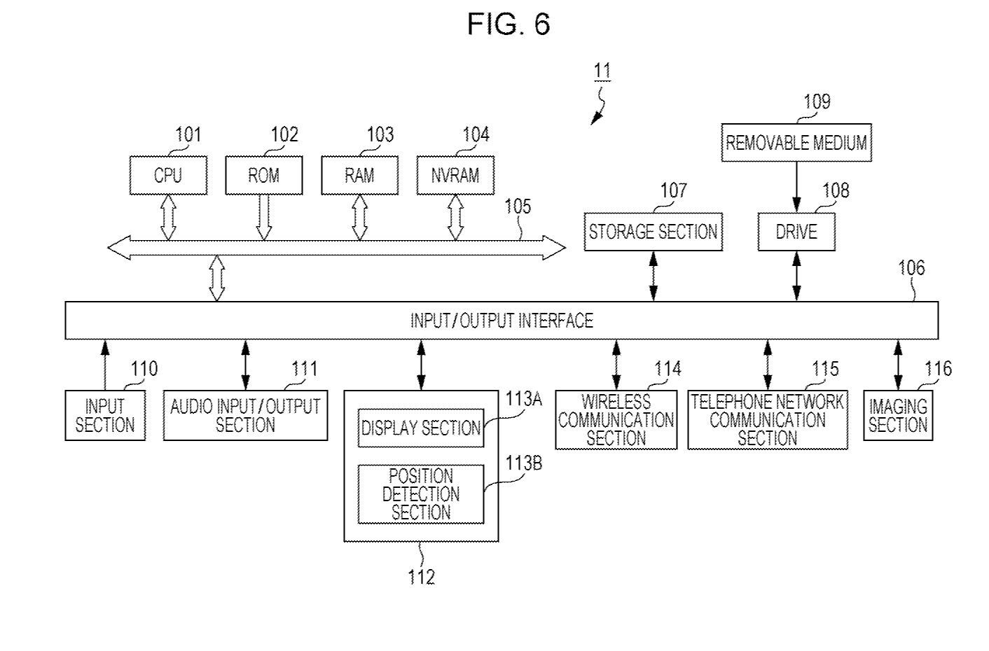

FIG. 6 is a block diagram illustrating an example of a hardware configuration of a mobile terminal 11.

In FIG. 6, a Central Processing Unit (CPU) 101 functions as an operation processing unit configured to execute various kinds of processing. For example, the CPU 101 executes the Web browser 43, and so on. The CPU 101 is mutually connected with a Read Only Memory (ROM) 102, a Random Access Memory (RAM) 103, and an Non Volatile RAM (NVRAM) 104 through a bus 105. An input/output interface 106 is also connected to a bus 105. A storage section 107, and a drive 108 are connected to the input/output interface 106.

The ROM 102 stores a basic program, such as an Operating System (OS), and so on, and data in advance. Application programs and data stored in the ROM 102 and the storage section 107 are loaded into the RAM 103 and the NVRAM 104. Also, necessary data, and so on for the CPU 101 to execute various kinds of processing are suitably stored in the RAM 103 and the NVRAM 104. The storage section 107 is formed by a flash memory, and so on, and stores at least the Web browser 43.

The drive 108 reads data from a removable medium 109, such as a semiconductor memory, and so on, which is attached as necessary, and supplies the data to the CPU 101 through the input/output interface 106, and so on, and writes data supplied from the CPU 101 to the removable medium 109. The data to be read and written may include data of application programs to be installed.

An input section 110, an audio input/output section 111, a touch screen 112, a wireless communication section 114, a telephone line network communication section 115, and an imaging section 116 are connected to the input/output interface 106.

The input section 110 is formed by a keyboard, an operation button, or the like, and accepts input by user operation to supply the input to the CPU 101, and so on. The audio input/output section 111 is formed by a speaker, a microphone, and so on, and inputs and outputs sound for telephone conversation.

The touch screen 112 includes a display section 113A and a position detection section 113B, and is capable of various kinds of display and input operation by bringing a finger, and so on closer to or bringing into contact (touch). The touch screen 112 corresponds to the display section 44 in FIG. 3.

The display section 113A is formed by a device (display device), such as a liquid crystal, and so on, and displays an image in accordance with data supplied through the input/output interface 106.

The position detection section 113B is formed by, for example, a device having a function of accepting (detecting) external input (coming closer or contacting), such as a touch panel of an electrostatic method, and the like.

The touch screen 112 is made by integrating the above-described display section 113A and the position detection section 113B. The display section 113A displays an image, and the position detection section 113B is capable of accepting operation input (touch and coming close) from the outside on the image displayed on the display section 113A.

A position signal output by the position detection section 113B is supplied to the CPU 101 through the input/output interface 106. The CPU 101 recognizes what kind of operation input has been performed on the basis of the position signal from the position detection section 113B, and performs various kinds of processing in accordance with the operation input.

The wireless communication section 114 performs wireless communication by the WiFi method, and so on. The telephone line network communication section 115 performs voice communication or packet communication with the other apparatuses through a mobile telephone communication network. The imaging section 116 includes an imaging element, such as a Charge Coupled Device (CCD) or Complementary Mental Oxide Semiconductor (CMOS) sensor, and so on. The imaging section 116 shoots a subject, and supplies image data of the captured subject to the CPU 101, and so on through the input/output interface 106. The imaging section 116 corresponds to the imaging section 41 in FIG. 3.

The mobile terminal 11 configured as described above may further include a non-contact communication section which performs non-contact communication using electromagnetic induction in a short distance of about a few centimeters, a wireless communication section by a Bluetooth (a registered trademark) method, an infrared communication section which performs communication by infrared rays, and so on, and the other configurations.

### 5. Example of Hardware Configuration of Web Server

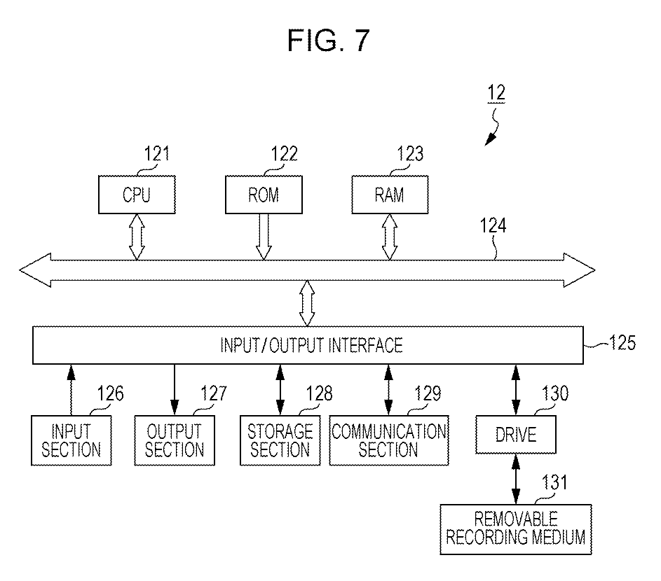

FIG. 7 is a block diagram illustrating an example of a hardware configuration of the Web server 12.

In the Web server 12, a CPU 121, a ROM 122, a RAM 123 are mutually connected through a bus 124.

Further, an input/output interface 125 is connected to the bus 124. An input section 126, an output section 127, a storage section 128, a communication section 129, and a drive 130 are connected to the input/output interface 125.

The input section 126 is formed by a keyboard, a mouse, a microphone, or the like. The output section 127 is formed by a display, a speaker, or the like. The storage section 128 is formed by a hard disk, a nonvolatile memory, or the like. The communication section 129 is formed by a network interface, or the like. The drive 130 drives a removable recording medium 131, such as a magnetic disk, an optical disc, a magneto-optical disc, or a semiconductor memory, or the like.

In the Web server 12 as described above, the CPU 121 loads the programs stored, for example, in the storage section 128 to the RAM 123 through the input/output interface 125 and the bus 124, and executes the programs so that a series of processing for achieving the real comment function is performed.

In the Web server 12, it is possible to install the programs into the storage section 128 through the input/output interface 125 by attaching the removable recording medium 131 to the drive 130. Also, it is possible to receive the programs by the communication section 129 through a wired or a wireless transmission medium, such as a local area network, the Internet, and digital satellite broadcasting, and to install the programs in the storage section 128. In addition, it is possible to install the programs in the ROM 122 or the storage section 128 in advance.

### 6. Real Comment Processing

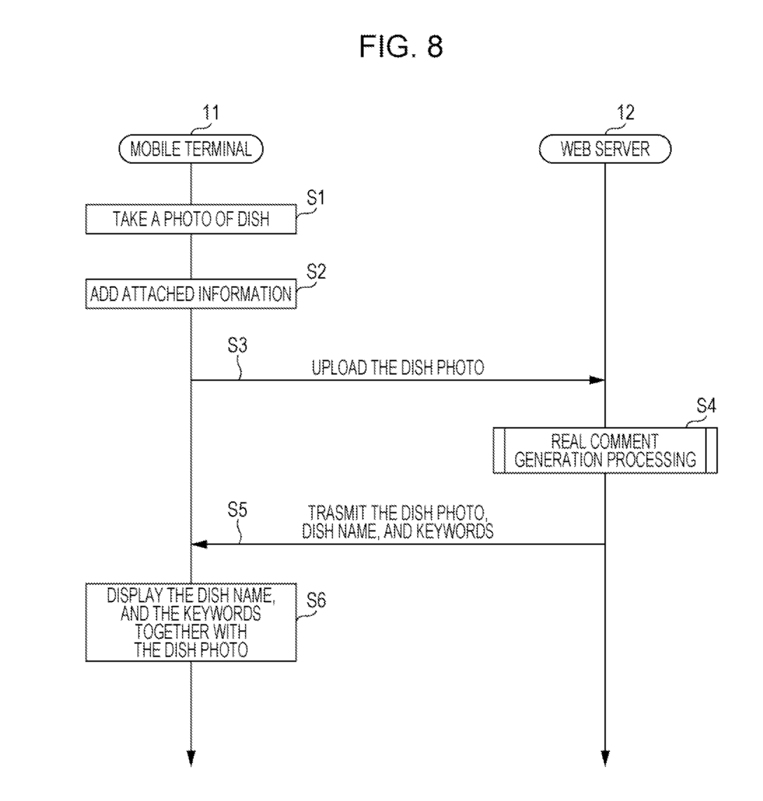

Next, a description will be given of the real comment processing described in FIG. 2 with reference to the flowchart in FIG. 8.

First, in step S1, the imaging section 41 of the mobile terminal 11 shoots a predetermined dish, for example, “dessert of marron pie including chestnuts boiled with astringent coat” (FIG. 2) in accordance with an imaging instruction by a user. The imaging section 41 generates image data of the dish photo shot in a predetermined format, such as Joint Photographic Experts Group (JPEG), and so on.

In step S2, the attached information addition section 42 adds attached information, such as shooting time, positional information, and so on to the image data of the shot dish photo, and shapes the image data of the shot dish photo in accordance with a predetermined format, such as Exif format, and so on.

In step S3, the Web browser 43 accesses the Web server 12 in accordance with operation by the user, and uploads (transmits) the image data of the dish photo to the Web server 12.

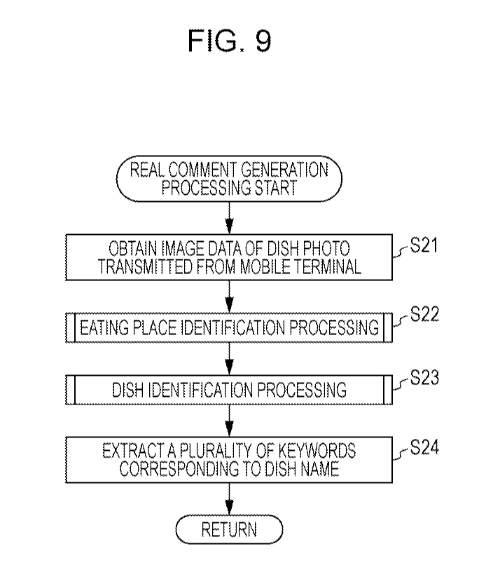

In step S4, the Web server 12 receives the image data of the dish photo from the mobile terminal 11, and performs real comment generation processing which generates a dish name of the dish taken in the dish photo, and keywords as comments. The details of this processing will be described later with reference to FIG. 9, and so on.

In step S5, the Web server 12 transmits the dish name and the keywords that are generated by the real comment generation processing to the mobile terminal 11 together with the dish photo.

In step S6, the Web browser 43 of the mobile terminal 11 obtains the data transmitted from the Web server 12 through the communication section 46, and displays the dish name and the keywords together with the dish photo shot by the user. For example, as illustrated in FIG. 2B, on the dish photo of “dessert of marron pie including chestnuts boiled with astringent coat”, the dish name “dessert of marron pie including chestnuts boiled with astringent coat” and the keywords expressing the characteristics of this dish, “sweetness for adults”, “taste of chestnuts are marvelous”, and “syrupy taste” are displayed on the Web browser 43 of the display section 44.

### 6.1 Real Comment Generation Processing

Next, a description will be given of the details of the real comment generation processing performed as step S4 in FIG. 8 with reference to the flowchart in FIG. 9.

First, in step S21, the content collection section 81 of the Web server 12 obtains the image data of the dish photo transmitted from the mobile terminal 11 through the communication section 61, and stores the image data in the content DB 91. And the content collection section 81 supplies the obtained the image data of the dish photo to the eating place identification section 82, the dish identification section 83, and the keyword extraction section 84.

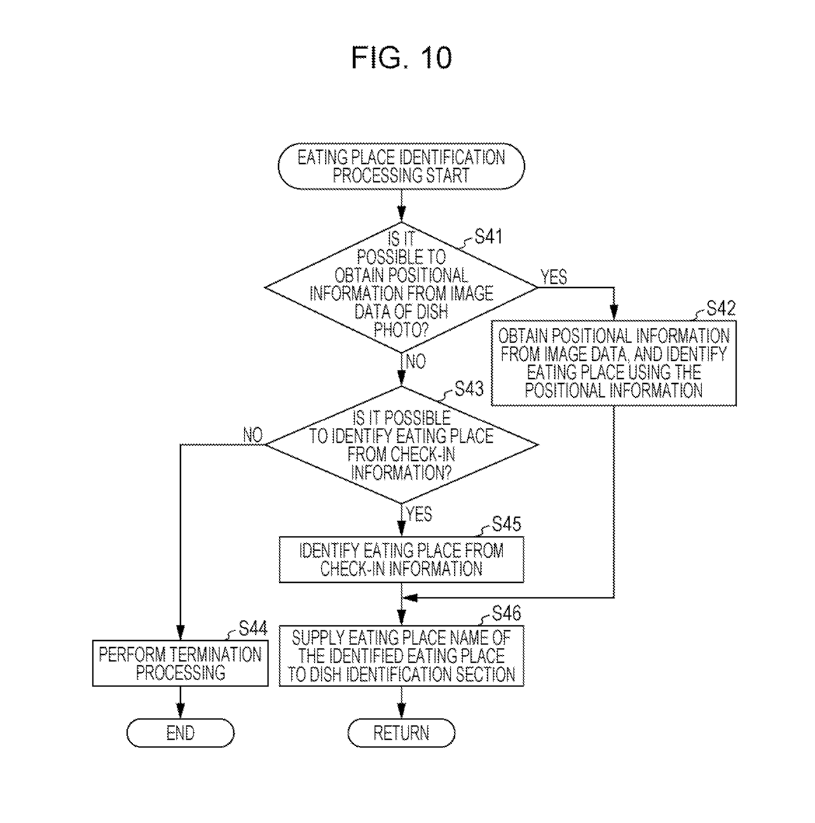

In step S22, the eating place identification section 82 performs eating place identification processing in which the eating place providing the dish shot there on the basis of the image data of the dish photo supplied from the content collection section 81. The information indicating the eating place identified by the identification processing is supplied to the dish identification section 83. The details of the eating place identification processing will be described later with reference to FIG. 10.

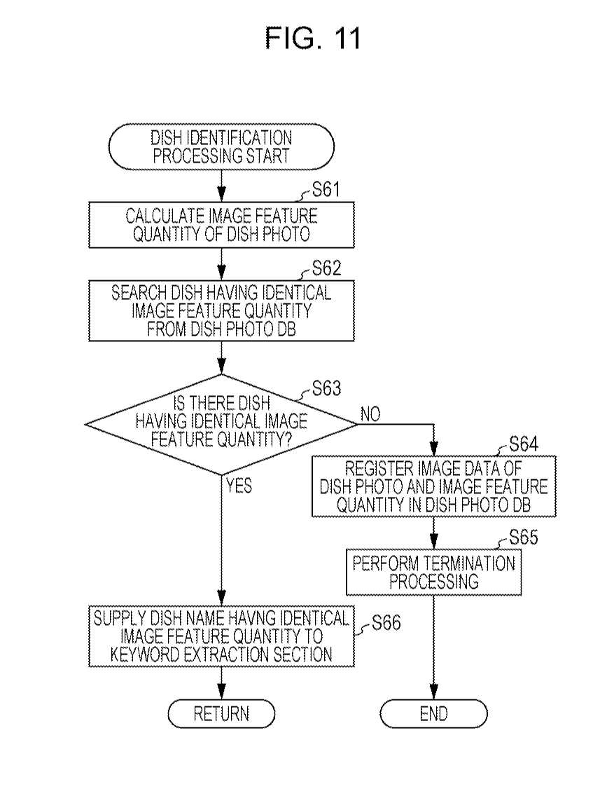

In step S23, the dish identification section 83 performs dish identification processing in which the dish taken in the dish photo is identified using the information of the eating place identified by the eating place identification section 82. The details of the dish identification processing will be described later with reference to FIG. 11.

In step S24, the keyword extraction section 84 extracts a plurality of keywords expressing the characteristics of the dish on the basis of the eating place identified by the eating place identification section 82 and the dish (the dish name thereof) identified by the dish identification section 83. More specifically, the keyword extraction section 84 refers to the dish keyword DB 94 (FIG. 5) storing the keywords for each dish (name) provided there for each eating place, and extracts a predetermined number of keywords from the keywords associated with the identified dish.

As described above, in the real comment generation processing, the dish name of the dish taken in the dish photo and the keyword to be displayed as comments are generated from the received dish photo.

### 6.2 Eating Place Identification Processing

Next, a description will be given of the details of the eating place identification processing executed as step S22 in FIG. 9 with reference to the flowchart in FIG. 10.

First, in step S41, the eating place identification section 82 determines whether it is possible to obtain positional information from the image data of the dish photo, that is to say, whether positional information is added to the image data of the dish photo as attached information or not.

In step S41, if determined that it is possible to obtain positional information from the image data of the dish photo, the processing proceeds to step S42, and the eating place identification section 82 obtains positional information from the image data of the dish photo. The eating place identification section 82 identifies an eating place using the obtained positional information. Specifically, the eating place identification section 82 detects an eating place having positional information identical to the obtained positional information from the eating places stored in the eating place DB so as to identify the eating place. After step S42, the processing proceeds to step S46.

On the other hand, in step S41, if determined that it is not possible to obtain positional information from the image data of the dish photo, the processing proceeds to step S43. The eating place identification section 82 determines whether it is possible to identify an eating place from check-in information by a check-in function. The check-in function is a function of registering own positional information (including an eating place, a spot, and so on) of a user in an SNS, and allows the user to save his or her own behavior history, and to inform friends of his or her location.

In step S43, if determined that it is not possible to identify an eating place from the check-in information, the processing proceeds to step S44, and the eating place identification section 82 performs termination processing to terminate the real comment generation processing itself. For example, the eating place identification section 82 performs transmission processing to transmits a message of “this eating place is not registered”, and so on to the mobile terminal 11, and the like as the termination processing.

On the other hand, in step S43, if determined that it is possible to identify an eating place from the check-in information, the processing proceeds to step S45, and the eating place identification section 82 identifies an eating place on the basis of the check-in information.

And in step S46, the eating place identification section 82 supplies the eating place name of the identified eating place to the dish identification section 83, and terminates the eating place identification processing.

### 6.3 Dish Identification Processing

Next, a description will be given of details of dish identification processing performed as step S23 in FIG. 9 with reference to the flowchart in FIG. 11.

In step S61, the dish identification section 83 calculates an image feature quantity of the dish photo supplied from the content collection section 81. Here, the calculated image feature quantity is not particularly limited, and it is possible to employ a feature quantity suitable for identifying a dish.

In step S62, the dish identification section 83 searches the dish photo DB 93 for a dish having an identical image feature quantity of the dish photo transmitted from the mobile terminal 11.

And in step S63, the dish identification section 83 determines whether there is a dish having an image feature quantity identical to the image feature quantity of the dish photo from the dish photo DB 93.

In step S63, if determined that there is not a dish having an image feature quantity identical to the image feature quantity of the dish photo from the dish photo DB 93, the processing proceeds to step S64, and the dish identification section 83 registers the image data of the dish photo transmitted from the mobile terminal 11 and the image feature quantity thereof in the dish photo DB 93. At this time, since the dish name is not identified, it is possible to allow the user of the mobile terminal 11 to enter the dish name.

If the dish (name) taken in the dish photo is not registered, the keywords of the dish are not registered in the dish keyword DB 94, and thus the dish identification section 83 performs termination processing to terminate the real comment generation processing itself in step S65. For example, the dish identification section 83 performs processing to transmit a message, such as “Please post comments on this dish”, and so on to the mobile terminal 11, and the like as termination processing.

On the other hand, in step S63, if determined that there is a dish having an image feature quantity identical to the image feature quantity of the dish photo from the dish photo DB 93, the processing proceeds to step S66. The dish identification section 83 supplies the dish name having the identical image feature quantity to the keyword extraction section 84, terminates the dish identification processing, and returns to FIG. 9.

As described above, in the dish identification processing, the dish name which has bee searched for using the image feature quantity is supplied to the keyword extraction section 84. After that, as described above, the keyword extraction section 84 extracts a plurality of keywords corresponding to the searched dish name from the dish keyword DB 94.

### 7. Examples of User Interfaces

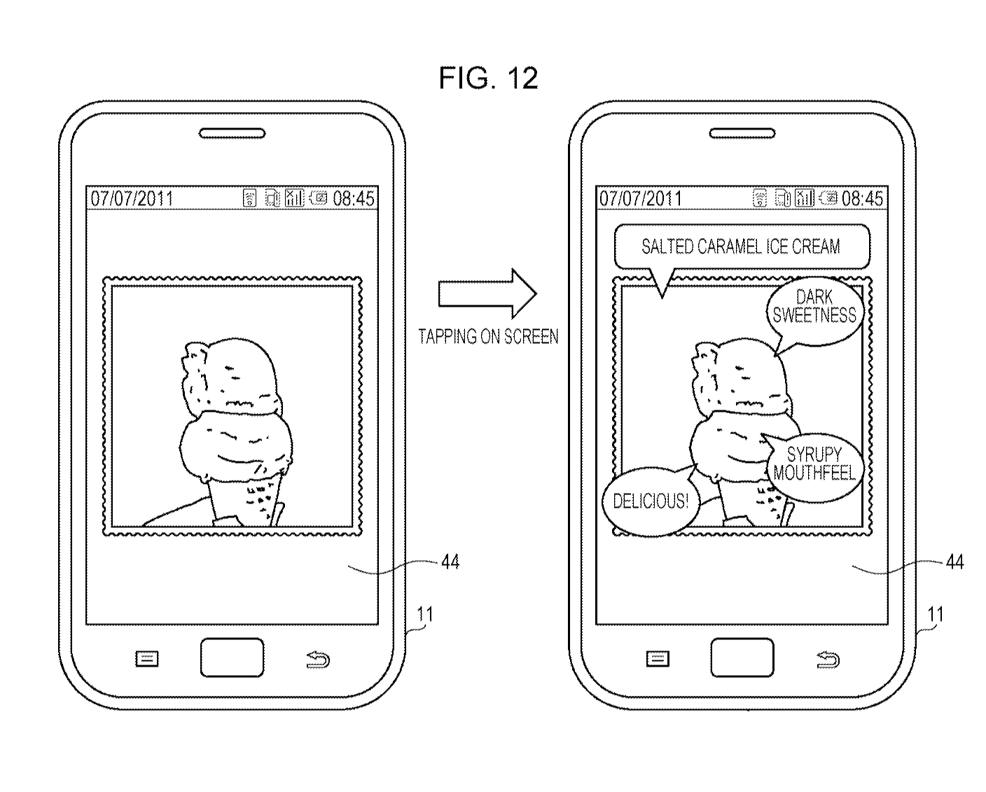

FIG. 12 to FIG. 15 illustrate examples of user interfaces of the real comment function.

FIG. 12 illustrates an example of screens illustrated on the display section 44 of the mobile terminal 11 when a user shot “salted caramel ice cream” at an eating place of a certain restaurant, and transmitted the image to the Web server 12.

After the user transmitted the dish photo of “salted caramel ice cream” to the Web server 12, if the user taps the screen of the display section 44 of the mobile terminal 11, a predetermined number of comments are displayed together with the dish name. In the example in FIG. 12, three comments “dark sweetness”, “delicious!”, and “syrupy mouthfeel” are displayed together with the dish name “salted caramel ice cream”.

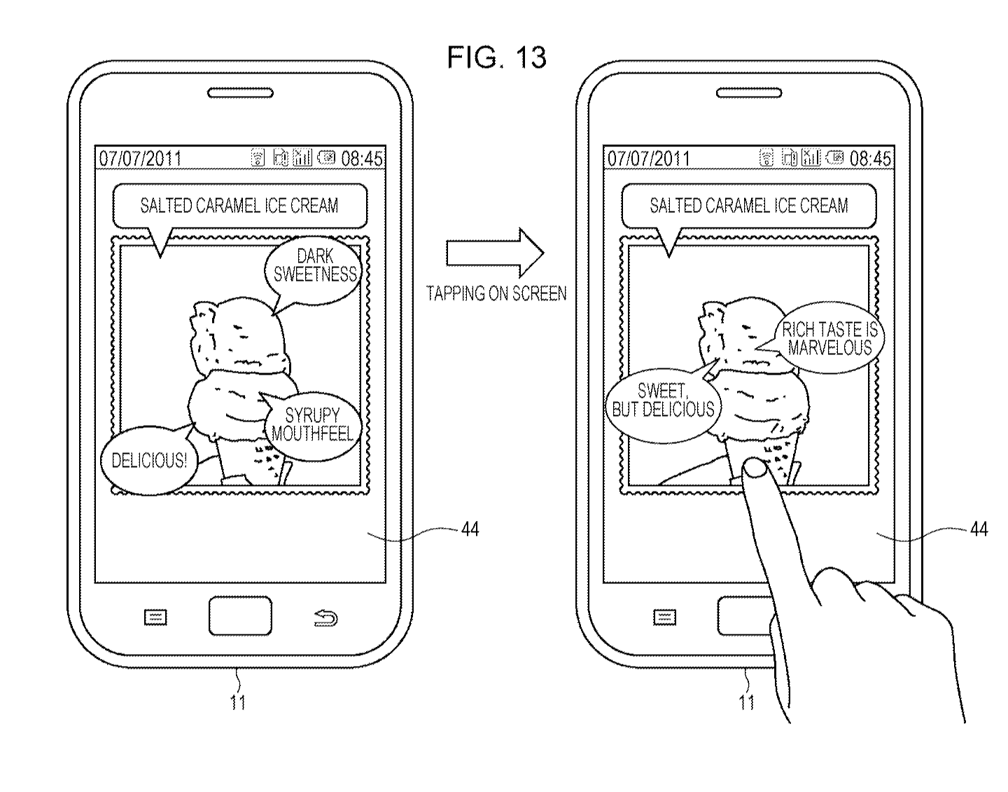

If the user taps the screen of the display section 44 of the mobile terminal 11 once again, as illustrated in FIG. 13, the next comments “rich taste is marvelous” and “sweet, but delicious” are selected from the dish keyword DB 94, and are displayed on the display section 44. The order to display the comments can be made in reverse chronological order of date and time at which the comments are posted with the newest comment at the top, for example. Also, in the case of updating a comment, by changing a position at which a comment is displayed before and a position at which a comment is displayed this time, it is possible for the user to notice that the display of the comments are updated.

In the case of the mobile terminal 11 having a small screen size, such as a smart phone, and so on, if a lot of comments are displayed once, the dish photo becomes difficult to be viewed, or the comments become difficult to be read. Thus, as illustrated in FIG. 12 and FIG. 13, a user interface is employed such that the number of the comments displayed at one time is limited, and when tapped, the other comments are displayed in sequence. Alternatively, for every passage of a certain time, such as for every three seconds, and so on, a predetermined number of comments may be displayed in sequence.

Also, a user interface may be employed in which displaying comments are turned on and off by a tapping operation, and the next comment is displayed by slide operation (flick operation), and so on.

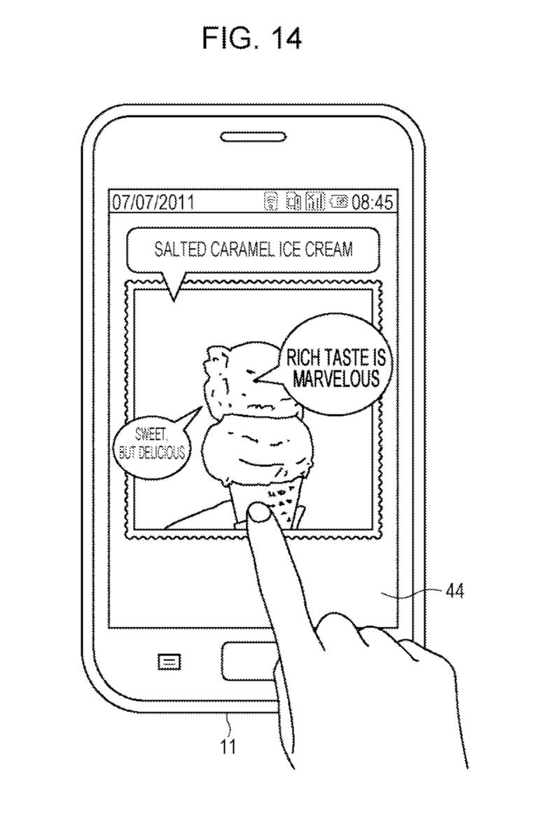

In the case of displaying a plurality of comments on the screen at the same time, for example, as illustrated in FIG. 14, it is possible to make a new comment noticeable with a large font in accordance with the past date (date and time) at which the comment was posted, and to make an old comment to be displayed with a small font.

Alternatively, the density of a background color of a balloon in which a comment is displayed may be changed in accordance with the posted date, for example the density may be increased for a new comment, and may be decreased as the comment becomes older. In this manner, a method of displaying comments may be changed in accordance with the date information (chronological order) of the posted comments.

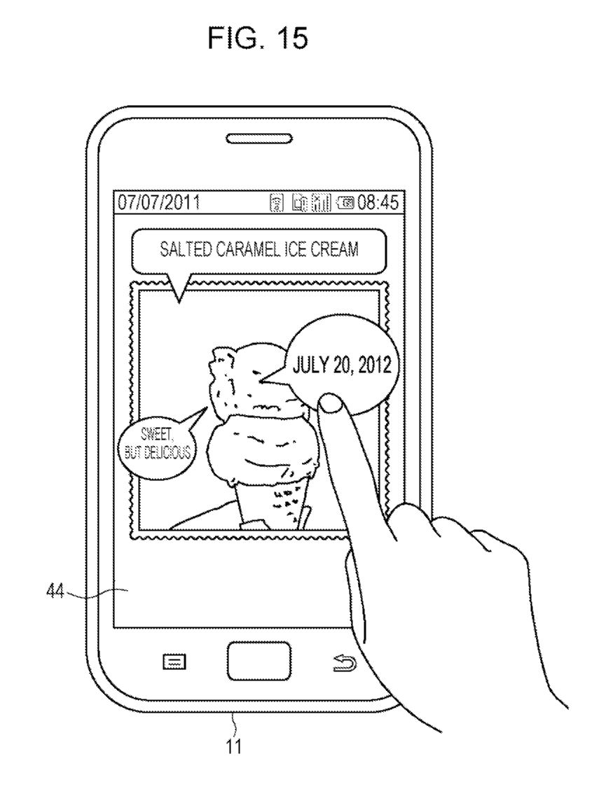

Also, as illustrated in FIG. 15, if the user taps on the balloon of the displayed comment, it is possible to display the date on which the comment was posted in place of the comment. Thereby, it is possible for the user to learn the date at which the comment has been posted.

Alternatively, if the user taps on the displayed comment, a poster (or a nickname) who has posted the comment including the keyword may be displayed, or a link to the posted comment of the poster (a function of jumping to an URL at which the posted comment is displayed) may be displayed.

In this regard, in this manner, in the case where information related to the comment is displayed when a balloon of the comment is tapped, if the balloon of the comment is displayed at the place where the user taps on, the user might tap the balloon unconsciously, and the information related to the comment might be displayed unintentionally. Thus, when a screen display is updated to display a plurality of next comments, it is possible not to display a comment at a position where the user has tapped on.

The above-described example is an example in which comments are displayed in reverse chronological order of date and time at which the comments were posted. However, a way of determining priorities for displaying comments is not limited to this. For example, comments may be displayed in descending order of the rating (reliability) of the poster who posted the comment including the keywords, or comments may be displayed in descending order of the rating (for example, the number of the “Like” buttons pressed) of the contributions given to the posted comment from which the keywords are extracted.

Alternatively, comments may be displayed in descending order of a posting frequency of the keyword, that is to say, in descending order of the number of posted keywords. Alternatively, user's preference to dishes may be stored, and comments may be displayed in order of keywords that are closer to the user's preference.

It is possible to specify by which priority the comments are displayed in a setting screen of the mobile terminal 11 or the Web server 12.

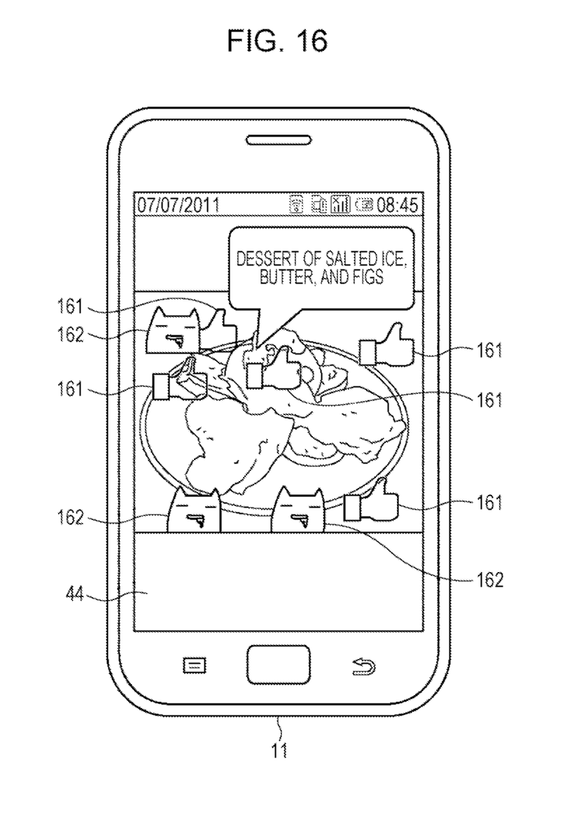

In this regard, in the above-described example, the character strings (keywords) extracted from the posted comment are displayed as review information superimposedly on the uploaded dish photo. However, as illustrated in FIG. 16, the “Like” icon 161 and the “Drool” icon 162 may be displayed as review information. To put it in another way, the review information that is superimposedly displayed on the dish photo of the mobile terminal 11 by the real comment function includes not only the keywords (words) extracted from the posted comment themselves, but also graphic symbols, such as icons expressing the keywords, and icons corresponding to the social buttons (for example, the “Like” button) pressed by the other users sharing the information, and so on.

### 8. Keyword Registration Processing

Next, a description will be given of registration processing for registering keywords to the dish keyword DB 94.

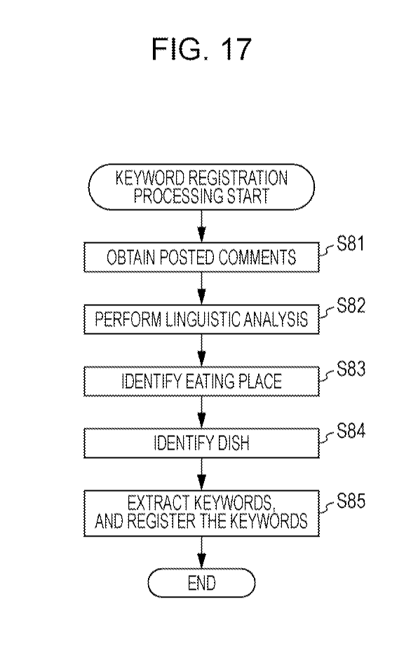

After a user ate a dish at an eating place of a restaurant, the user posts a comment on the dish on the spot, or posts impressions on the dish at the restaurant where the user visited on that day after returning home, and so on to the Web server 12. In such a case, the keyword registration processing in FIG. 17 is executed.

First, in step S81, the content collection section 81 of the Web server 12 obtains the posted comment of the user, which is transmitted from the mobile terminal 11, through the communication section 61.

In step S82, the content collection section 81 performs linguistic analysis, such as syntax analysis (morphological analysis), semantic analysis, and the like on the obtained posted comment. That is to say, the content collection section 81 analyzes the obtained posted comment into linguistic minimum units, determines parts of speech of each word analyzed, and determines the contents. For a method of linguistic analysis, it is possible to use any well-established techniques, such as Japanese Unexamined Patent Application Publication Nos. 1998-021243, 2000-137708, and 2003-030184, and so on, for example. The analysis result of the linguistic analysis by the content collection section 81 is supplied to the eating place identification section 82, the dish identification section 83, and the keyword extraction section 84.

In step S83, the eating place identification section 82 identifies an eating place to which comments are given by the posted comment using the linguistic analysis result from the content collection section 81. Identification of an eating place may be performed using the check-in information, and so on.

In step S84, the dish identification section 83 identifies a dish to which comments are given by the posted comments using the linguistic analysis result from the content collection section 81. If a dish photo is uploaded at the same time with the posted comment, a dish(name) may be identified from the dish photo using image feature quantities of the dishes of each eating place stored in the dish photo DB 93.

In step S85, the keyword extraction section 84 extracts keywords on the dish using the linguistic analysis result from the content collection section 81, and registers the keywords to the corresponding place in the dish keyword DB 94. That is to say, the extracted keywords are registered in the place of the dish name identified in step S84 of the eating place identified in step S83 in the dish keyword DB 94.

As described above, keywords are extracted from the posted comment by the user on the dish, and are registered in the dish keyword DB 94.

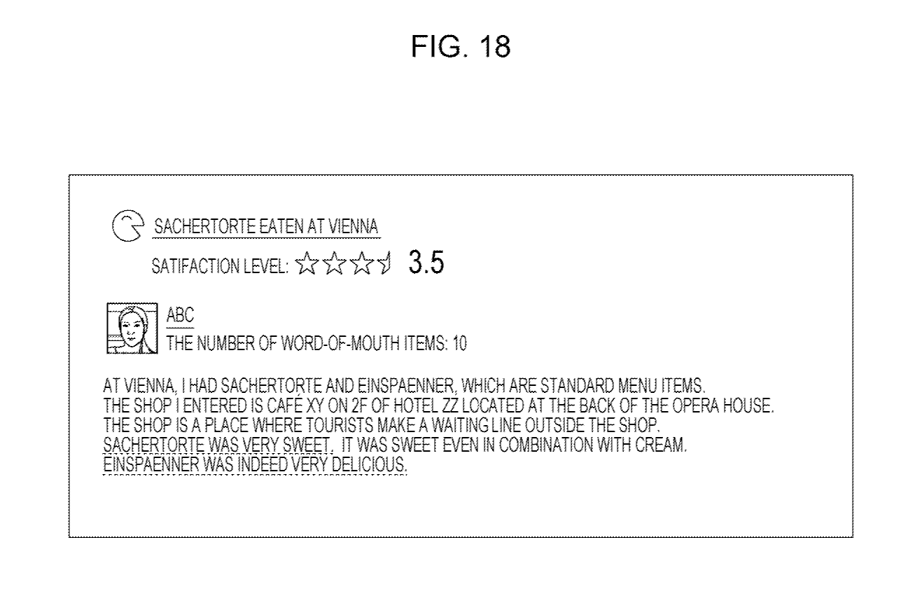

FIG. 18 illustrates an example in which keywords are extracted from a posted comment on a dish by a user.

In the example of the posted comments illustrated in FIG. 18, “Cafe XY” is identified as an eating place name. And for the dish name “Sachertorte”, the keyword “it was very sweet” or “very sweet” is registered, and for the dish name “Einspaenner”, the keyword “indeed very delicious” or “delicious” is extracted, and registered.

In this regard, at the time of registering a keyword in the dish keyword DB 94, for example, a synonym, such as “sweet”, “very sweet”, “greatly sweet”, “sweet and sweet”, and so on may be put together to one keyword, such as “very sweet”, and so on, and a posting frequency may be counted up, or the like.

It is possible to use the keywords stored in the dish keyword DB 94 for an autocomplete function (automatic completion function) when the user posts comments on dishes at each eating place, and so on to an SNS. For example, when the user enters a character “a” as a posted comment, it is possible not to display “ashita (tomorrow in Japanese)”, “arigato (thank you in Japanese)” and so on, but to display “amai (sweet in Japanese)”, “aburakkoi (fatty in Japanese)”, “assari (plain in Japanese)”, and so on, which are registered in the dish keyword DB 94, as candidates for an input character string with priority. Also, in general, the keywords stored in the dish keyword DB 94 may be used for a character conversion program, such as Input Method Editor (IME), and so on.

Also, priority of automatic conversion candidate may be changed in accordance with classification of a recognized image. For example, if an image posted to an SNS by a user is a dish photo, words on a dish may be presented with high priority as an input character-string candidate and an character-conversion candidate, for example. Also, if an image posted is a clothes photo, words on clothes may be presented with high priority, for example.

In general, in an SNS, when a user posts a comment or a photo, a social button, as typified by the “Like” button, and so on is displayed. When the user uploads a dish photo to an SNS, the Web server 12 analyzes an image feature quantity of the uploaded image, and if the Web server 12 recognizes the uploaded image to be a dish photo, it is possible to display a “Look delicious” button in the SNS page in which the dish photo is displayed in place of the “Like” button. Also, it is possible for the Web server 12 to display a plurality of social buttons that are created by extracting adjective keywords stored in the dish keyword DB 94, such as a “Look sweet” button, a “Plain” button, a “Look salty” button, and so on in addition to the “Look delicious” button.

Also, when the user uploads a clothes photo to an SNS, it is possible for the Web server 12 to analyze an image feature quantity of the uploaded image to recognize the uploaded image to be a clothes photo, and to display a “Cool” button, a “Pretty” button, and so on in place of the “Like” button. That is to say, it is possible to change the display of the social button in accordance with the classification of the subject taken in a subject image.

### 9. The Other Applications

In the above-described embodiments, a dish provided at a restaurant is subjected to image recognition, and review information (comments) of the other users are displayed superimposedly. However, the present technique is not limited to a dish.

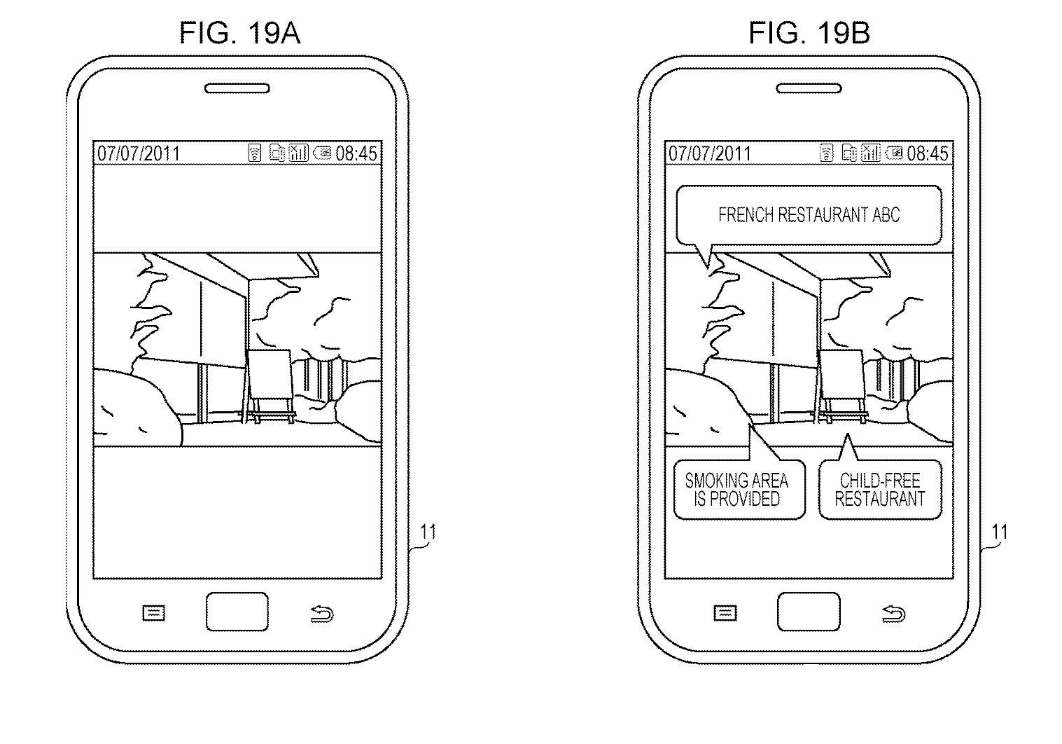

For example, as illustrated in FIG. 19, an application is thought in which when an outer view of a restaurant is captured, and is uploaded to the Web server 12, an eating place name of the restaurant, review information on the eating place, for example, “child-free”, “smoking area is provided”, “suitable for a date”, or “rest room is dirty”, and so on are displayed superimposedly.

In an SNS, an object to which users post opinions and comments is not limited to a dish. Thus, it is possible to apply the present technique to various things to which users post opinions and comments. For example, it is possible to apply the present technique to superimposed display of evaluation comments at shops (stores) of, such as clothes, accessories, and so on, and to superimposed display of introduction and evaluation comments on tourist sites and sightseeing spots, and so on. The review information that is displayed superimposedly on a subject image shot by a user is extracted from the information actually posted by the other users. By the present technique, it is therefore possible to provide new services that make better use of opinions and comments created by users.

In the above-described embodiment, a still image obtained by shooing a dish is uploaded to the Web server 12. However, a moving image (through image) obtained by capturing an image by the imaging section 41 in real time may be uploaded, and may be subjected to image recognition by the Web server 12.

In the case of performing image recognition on a moving image, it is possible to obtain comments (keywords) in accordance with the images captured at each point of the eating place from the database (storage section 63) of the Web server 12, and to display the comments. For example, in the example of the above-described restaurant, when an outer view of the restaurant is captured, a comment, such as “Smoking area is provided” and so on is displayed. Next, when an entrance to the eating place is shot, a comment, such as “Mind the steps” and so on is displayed. When a dish is shot, a comment, such as “delicious”, and so on is displayed.

In this regard, in the case of performing image recognition on a moving image, there is concern that an image feature quantity obtained from a moving image becomes unstable by a change of scenes as a subject, an image shake, and so on. In this case, for example, it is possible to set a threshold value for variations in the image feature quantity. And if a state in which a variation in the image feature quantity exceeds the threshold value continues for a certain time period, it is recognized that the next different point appears. Alternatively, it is possible to perform point-recognition processing in which each point is recognized using an average value of the image feature quantities of a plurality of consecutive still images in time, and so on.

Embodiments of the present technique are not limited to the above-described embodiments, and various variations are possible without departing from the spirit and scope of the present technique.

Division of the processing functions between the mobile terminal 11 and the Web server 12 is not limited to the above-described example, and can be suitably determined in accordance with the processing power of each apparatus, convenience, and so on. For example, in the mobile terminal 11 in the above-described example, image data of a dish photo taken by the imaging section 41 is transmitted to the Web server 12. However, the calculation (extraction) of the image feature quantity of a dish photo may be carried out by the mobile terminal 11, and the calculated image feature quantity may be transmitted to the Web server 12.

It is possible to configure the present technique by cloud computing, in which one function is shared and coordinated by a plurality of apparatuses through a network.

Also, it is possible to share each step described in the above flowchart among a plurality of apparatuses in addition to performing each step by one apparatus.

Further, in the case where one step includes a plurality of pieces of processing, the plurality of pieces of processing included in the one step may be shared and executed by a plurality of apparatuses in addition to execution by one apparatus.

In the present specification, the steps described in the flowchart are executed in time series in accordance with the described sequence as a matter of course. Alternatively, the steps may not be executed in time series, but may be executed in parallel or at necessary timing, such as at the time of being called, or the like.

Also, in the present specification, a system means a set of a plurality of components (apparatuses, modules (parts), and so on), and it does not matter whether all the components are contained in a same case or not. Accordingly, a plurality of apparatuses that are accommodated in separate cases and connected through a network, and a plurality of modules accommodated in one case are both systems.

In this regard, the present technique can be configured as follows.

(1) A terminal apparatus including:

a transmission section configured to transmit a subject image obtained by shooting a predetermined subject or an image feature quantity thereof to another information processing apparatus; from the other information processing apparatus configured to recognize the subject of the subject image on the basis of the image feature quantity, to determine review information stored in the other information processing apparatus by a social networking service to be corresponding to the subject image, and to transmit the review information, a reception section configured to receive the review information; and a display section configured to display the received review information together with the subject image.

(2) The terminal apparatus according to (1), wherein the transmission section is configured to add positional information indicating a shooting location to the subject image, and to transmit the subject image, and the reception section is configured to receive the review information determined by the other information processing apparatus using the positional information.

(3) The terminal apparatus according to (1) or (2), wherein the transmission section is configured to transmit check-in information of the social networking service indicating a user location to the other information processing apparatus, and the reception section is configured to receive the review information determined by the other information processing apparatus using the check-in information in addition.

(4) The terminal apparatus according to any one of (1) to (3), further including an imaging section configured to shoot the predetermined subject.

(5) The terminal apparatus according to any one of (1) to (4), wherein if the review information is selected by a user, the display section is configured to display related information relating to the review information.

(6) The terminal apparatus according to any one of (1) to (5), wherein the review information is displayed in reverse chronological order of date and time at which the information has been posted.

(7) The terminal apparatus according to any one of (1) to (6), wherein the review information is displayed in descending order of rating for a poster of a posted comment including the information.

(8) The terminal apparatus according to any one of (1) to (7), wherein the review information is displayed in descending order of rating for a posted comment including the information.

(9) The terminal apparatus according to any one of (1) to (8), wherein the review information is displayed in descending order of posting frequency.

(10) The terminal apparatus according to any one of (1) to (9), wherein the review information is displayed in order of preference closer to that of a user who shot the subject image.

(11) A method of controlling a terminal, the method including: transmitting a subject image obtained by shooting a predetermined subject or an image feature quantity thereof to another information processing apparatus; from the other information processing apparatus configured to recognize the subject of the subject image on the basis of the image feature quantity, to determine review information stored in the other information processing apparatus by a social networking service to be corresponding to the subject image, and to transmit the review information, receiving the review information; and displaying the received review information together with the subject image on a display section.

(12) A program for causing a computer to perform processing including: transmitting a subject image obtained by shooting a predetermined subject or an image feature quantity thereof to another information processing apparatus; from the other information processing apparatus configured to recognize the subject of the subject image on the basis of the image feature quantity, to determine review information stored in the other information processing apparatus by a social networking service to be corresponding to the subject image, and to transmit the review information, receiving the review information; and displaying the received review information together with the subject image on a display section.

(13) An information processing apparatus including: a storage section configured to store review information extracted from posted information on a predetermined subject posted by a social networking service; a reception section configured to receive a subject image obtained by a terminal apparatus shooting the subject or an image feature quantity thereof; a review information determination section configured to determine review information corresponding to the subject image received or the image feature quantity thereof on the basis of the review information stored in the storage section; and a transmission section configured to transmit the review information determined as review information corresponding to the subject image.

(14) A method of processing information, the method including: storing review information extracted from posted information on a predetermined subject posted by a social networking service into a storage section; receiving a subject image obtained by a terminal apparatus shooting the subject or an image feature quantity thereof; determining review information corresponding to the subject image received or the image feature quantity thereof on the basis of the review information stored in the storage section; and transmitting the review information determined as review information corresponding to the subject image.

(15) A program for causing a computer to perform processing including: storing review information extracted from posted information on a predetermined subject posted by a social networking service into a storage section; receiving a subject image obtained by a terminal apparatus shooting the subject or an image feature quantity thereof; determining review information corresponding to the subject image received or the image feature quantity thereof on the basis of the review information stored in the storage section; and transmitting the review information determined as review information corresponding to the subject image.

What is claimed is:

1. A terminal apparatus comprising:
a transmission section configured to transmit a subject image obtained by shooting a predetermined subject or an image feature quantity thereof to another information processing apparatus;
from the other information processing apparatus configured to recognize the subject of the subject image on the basis of the image feature quantity, to determine review information stored in the other information processing apparatus by a social networking service to be corresponding to the subject image, and to transmit the review information, a reception section configured to receive the review information; and
a display section configured to display the received review information together with the subject image.

2. The terminal apparatus according to claim 1,
wherein the transmission section is configured to add positional information indicating a shooting location to the subject image, and to transmit the subject image, and
the reception section is configured to receive the review information determined by the other information processing apparatus using the positional information.

3. The terminal apparatus according to claim 1,
wherein the transmission section is configured to transmit check-in information of the social networking service indicating a user location to the other information processing apparatus, and
the reception section is configured to receive the review information determined by the other information processing apparatus using the check-in information in addition.

4. The terminal apparatus according to claim 1, further comprising an imaging section configured to shoot the predetermined subject.

5. The terminal apparatus according to claim 1,
wherein if the review information is selected by a user, the display section is configured to display related information relating to the review information.

6. The terminal apparatus according to claim 1,
wherein the review information is displayed in reverse chronological order of date and time at which the information has been posted.

7. The terminal apparatus according to claim 1,
wherein the review information is displayed in descending order of rating for a poster of a posted comment including the information.

8. The terminal apparatus according to claim 1,
wherein the review information is displayed in descending order of rating for a posted comment including the information.

9. The terminal apparatus according to claim 1,
wherein the review information is displayed in descending order of posting frequency.

10. The terminal apparatus according to claim 1,
wherein the review information is displayed in order of preference closer to that of a user who shot the subject image.

11. A method of controlling a terminal, the method comprising:
transmitting a subject image obtained by shooting a predetermined subject or an image feature quantity thereof to another information processing apparatus;
from the other information processing apparatus configured to recognize the subject of the subject image on the basis of the image feature quantity, to determine review information stored in the other information processing apparatus by a social networking service to be corresponding to the subject image, and to transmit the review information, receiving the review information; and
displaying the received review information together with the subject image on a display section.

12. A program for causing a computer to perform processing comprising:
transmitting a subject image obtained by shooting a predetermined subject or an image feature quantity thereof to another information processing apparatus;
from the other information processing apparatus configured to recognize the subject of the subject image on the basis of the image feature quantity, to determine review information stored in the other information processing apparatus by a social networking service to be corresponding to the subject image, and to transmit the review information, receiving the review information; and
displaying the received review information together with the subject image on a display section.

13. An information processing apparatus comprising:
a storage section configured to store review information extracted from posted information on a predetermined subject posted by a social networking service;
a reception section configured to receive a subject image obtained by a terminal apparatus shooting the subject or an image feature quantity thereof;
a review information determination section configured to determine review information corresponding to the subject image received or the image feature quantity thereof on the basis of the review information stored in the storage section; and
a transmission section configured to transmit the review information determined as review information corresponding to the subject image.

14. A method of processing information, the method comprising:
storing review information extracted from posted information on a predetermined subject posted by a social networking service into a storage section;
receiving a subject image obtained by a terminal apparatus shooting the subject or an image feature quantity thereof;
determining review information corresponding to the subject image received or the image feature quantity thereof on the basis of the review information stored in the storage section; and
transmitting the review information determined as review information corresponding to the subject image.

15. A program for causing a computer to perform processing comprising:
storing review information extracted from posted information on a predetermined subject posted by a social networking service into a storage section;
receiving a subject image obtained by a terminal apparatus shooting the subject or an image feature quantity thereof;
determining review information corresponding to the subject image received or the image feature quantity thereof on the basis of the review information stored in the storage section; and
transmitting the review information determined as review information corresponding to the subject image.
